(19) United States
(12) Patent Application Publication
(10) Pub. No.: US 2023/0271551 A1
(43) Pub. Date: Aug. 31, 2023

(54) Haptic and/or Tactile Warning of People via a Vehicle

(71) Applicant: Robert Bosch GmbH, Stuttgart (DE)

(72) Inventors: Stefan Sellhusen, Sunnyvale, CA (US); Roland Werner, Sindelfingen (DE); Christoph Doerr, Koeln (DE); Florian Dumas, Herrenberg (DE)

(21) Appl. No.: 18/005,982

(22) PCT Filed: Jul. 21, 2021
(86) PCT No.: PCT/EP2021/070368

§ 371 Date: May 19, 2023

(30) Foreign Application Priority Data
Jul. 22, 2020 (DE) 10 2020 209 226.5

(51) Int. Cl. B60Q 9/00

(52) U.S. Cl. CPC B60Q 9/008

(57) ABSTRACT

An assembly is for outputting tactile warning signals in a vehicle environment of a vehicle and includes at least one sensor for scanning the vehicle environment and for detecting sensor data, and at least one signal generator for outputting a warning signal that is tactilely and/or haptically perceptible to people in the vehicle environment. The assembly further includes a control device for receiving and evaluating the sensor data and for generating control commands for actuating the signal generator in the event of a person being detected in the vehicle environment.

The invention relates to an assembly for outputting tactile and/or haptic warning signals in a vehicle environment of a vehicle. The invention further relates to a method, to a control device, to a computer program, and to a machine-readable storage medium.

### PRIOR ART

The slow starting movement from a stopped or stopping position poses a particular challenge for vehicles operated in an automated manner and vehicles having driver assistance functions. The vehicle usually communicates with people in a vehicle environment via visual or acoustic signals.

For example, visual or acoustic warnings in the form of light signals from the vehicle lighting system or in the form of signal tones from loudspeakers of the vehicle to the environment thereof are output by the vehicle in order to indicate to the people located in said environment that the vehicle is starting to move.

However, it is problematic that, in particular, pedestrians and cyclists in road traffic frequently use electronic devices such as smartphones, sometimes in combination with headphones, and as a result cannot perceive acoustic and visual signals of vehicles.

### DISCLOSURE OF THE INVENTION

The object of the invention can be considered that of proposing an assembly and a method for reliably indicating to people that a starting movement of a vehicle is imminent.

This object is achieved by means of the subject matter of the independent claims. Advantageous embodiments of the invention are the subject matter of the dependent claims.

According to one aspect of the invention, an assembly for outputting tactile and/or haptic warning signals in a vehicle environment of a vehicle is provided. The vehicle can preferably be designed as a vehicle that can be operated in a fully automated manner.

The assembly comprises at least one sensor for scanning the vehicle environment and for detecting sensor data. Furthermore, at least one signal generator is provided for outputting a warning signal that is tactilely and/or haptically perceptible to people in the vehicle environment.

A control device is used to receive and evaluate the sensor data and to generate control commands for actuating the signal generator in the event of a person being detected in the vehicle environment.

In addition to conventional optical and acoustic warning of people, haptic or tactile warning of people can also be made possible by the method.

In this case, the at least one signal generator can generate pulses which are sensorially perceptible to people. For example, a blast of air, thermal radiation, or a vibration can be generated, by means of which the attention of people can be directed to the vehicle.

The person can be registered by evaluating measurement data from a camera, a LIDAR sensor, or a radar sensor. In particular, a person in the immediate proximity of the vehicle can be detected.

To increase traffic safety, a starting movement of the automatically operable vehicle is not possible as long as the person is located next to the vehicle. The control device can thus generate control commands for activating the signal generators, which can also warn a distracted person of the vehicle.

According to a further aspect of the invention, a control device is provided, wherein the control device is configured to carry out the method. The control device can be, for example, an on-board control device, an off-board control device, or an off-board server unit such as a cloud system.

Furthermore, according to one aspect of the invention, a computer program is provided which comprises commands which, when the computer program is executed by a computer or a control device, cause same to carry out the method according to the invention.

According to a further aspect of the invention, a machine-readable storage medium is provided, on which the computer program according to the invention is stored.

According to the BASt standard, the vehicle can be operated in an assisted, partially automated, highly automated and/or fully automated or driverless manner.

The vehicle may be, for example, a passenger car, a truck, a robotaxi, and the like. The vehicle is not limited to operation on roads. Rather, the vehicle can also be designed as a watercraft, an aircraft, such as a transport drone, and the like.

In one embodiment, the at least one signal generator is designed as a pressurized air nozzle, infrared source, and/or a vibration unit. The pressurized air nozzle may be connectable, for example, to a compressor or a compressed air reservoir in order to be able to generate a blast of air when necessary. By means of this measure, a person standing in the immediate vicinity of the vehicle can be subjected to the blast of air.

The use of an infrared source allows for the emission of thermal radiation, which can be used to heat a person. As a result, unnatural heating of the person can be used to direct their attention to the infrared source and thus also to the vehicle.

A vibration unit arranged on the vehicle is used to create an imbalance. In particular in the case of people who are touching the vehicle or leaning against the vehicle, such an oscillation can direct the attention of the person to the vehicle.

The vibration unit may, for example, be designed as an electromechanical converter comprising an electric motor or an electromagnet as a drive.

According to another embodiment, control commands for actuating one or more signal generators can be generated by the control device. By means of this measure, for example, multiple signal generators can be actuated simultaneously in order to warn one or more people.

According to another embodiment, different signal generators are arranged in different regions of the vehicle. For example, an infrared source may be positioned in a front and/or rear region of the vehicle. The pressurized air nozzles for generating blasts of air may be fastened to the sides of the vehicle, for example. Depending on the design, multiple different signal generators may also be positioned one next to the other.

According to another embodiment, a pulse or a pulse pattern may be output by the at least one signal generator. As a result, an increased level of attention can be achieved in the person. For example, the pulse of the signal generator can be generated as a sinusoidal oscillation or emitted into the vehicle environment.

In another embodiment, the signal generator has an effective radius in the vehicle environment that is at least 3 m. As a result, approval for a starting movement of the vehicle can take into account all people within a reduced radius. In particular, the resources required for evaluating the sensor data can be reduced.

One or more signal generators are arranged on the vehicle and can be actuated separately or in combination by the control device. By means of this measure, a plurality of people standing in the vehicle environment can be warned by the vehicle. For example, laterally arranged pressurized air nozzles and a front infrared source can be actuated by the control device.

According to a further aspect of the invention, a method for outputting warning signals in a vehicle environment of a vehicle is provided. The method can preferably be executed by a control device. The control device may be an on-board or off-board control device.

In a first step, sensor data are received from a vehicle environment and evaluated. When at least one person is detected in the vehicle environment, control commands are output to at least one signal generator. Subsequently, by means of the at least one actuated signal generator, a warning signal that is tactilely and/or haptically perceptible to the person in the vehicle environment is output.

According to one embodiment, at least one signal generator which is effective for a detected distance between the vehicle and the person in the vehicle environment is actuated depending on said distance. By means of this measure, different ranges of the signal generators can be taken into account when generating the warning signals.

For example, by means of a generated vibration or mechanical oscillation, only people standing directly at the vehicle and leaning against the vehicle can be warned. An infrared source has a higher range compared to the vibration unit. The pressurized air nozzle has a range which is between a range of the vibration unit and a range of the infrared source.

In particular, this measure allows only such signal generators to be actuated which can also achieve an effect with respect to the person. All other signal generators remain deactivated.

According to another embodiment, a pulse intensity of the warning signal is adapted depending on a detected distance between the vehicle and the person in the vehicle environment. Alternatively or additionally, a range of the signal generators can be controlled by influencing the pulse intensity. This can be implemented by setting a higher frequency or a higher electrical power. For this purpose, the control device may generate corresponding control commands which set or change an operating mode of the signal generator.

According to another embodiment, a selection of signal generators is actuated depending on a detected position of the person in the vehicle environment. As a result, multiple signal generators adjacent to the person can be activated by the control device in order to achieve a maximum level of attention of the person. As a result, a warning effect of the warning can be increased.

Preferred exemplary embodiments of the invention are explained in more detail below with reference to highly simplified schematic representations. In the drawings:

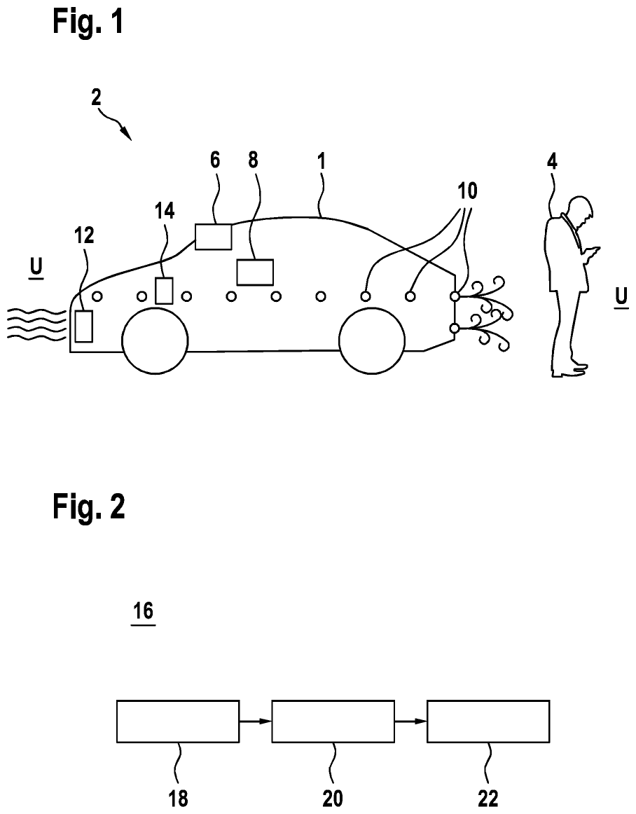

FIG. 1 is a schematic side view of a vehicle comprising an assembly according to one embodiment, and

FIG. 2 is a schematic flowchart for illustrating a method according to one embodiment.

FIG. 1 is a schematic side view of a vehicle 1 is an assembly 2 according to one embodiment. In the embodiment shown, the vehicle 1 is designed as an automatically operable vehicle 1. In particular, the vehicle 1 can be operated in a fully automated manner or without a driver.

The vehicle 1 comprises an assembly 2 which is used to output tactile and/or haptic warning signals in a vehicle environment U of the vehicle 1.

In particular, people 4 standing in the vehicle environment U can be warned by means of the warning signals generated in order to signal an approach of the vehicle 1.

The people 4 may be pedestrians, cyclists, animals, and the like.

The assembly 2 comprises at least one sensor 6 in order to monitor the vehicle environment U for people 4. The sensor 6 may be, for example, a camera sensor, a LIDAR sensor, a radar sensor, and the like.

The measurement data or sensor data detected by the sensor 6 can be received and evaluated by a control device 8. If a person 4 is noticed in the immediate environment of the vehicle 1, at least one signal generator 10, 12, 14 can be actuated by the control device 8 in order to motivate the person 4 to vacate the vehicle environment U.

The signal generator 10, 12, 14 may be designed, for example, as a pressurized air nozzle 10, an infrared source 12, or as a vibration unit 14. People 4 at a distance from the vehicle 1 can also be warned by means of the pressurized air nozzles 10 and infrared source 12.

The vibration unit 14 may, for example, cause part of a vehicle body to vibrate and thus alert or warn a person 4 that is in contact with the vehicle 1.

The assembly 2 and, in particular, the control device 8 can communicate with an approval module of the vehicle 1 in order to approve a starting movement of the vehicle 1.

If people 4 are noticed in the vehicle environment U, the approval for the starting movement cannot be granted. By means of the assembly 2, the people 4 are prompted to leave the vehicle environment U, as a result of which the approval for a starting movement of the vehicle 1 can be issued more quickly.

FIG. 2 is a schematic flowchart for illustrating a method 16 according to one embodiment. The method 16 is used to output warning signals in a vehicle environment U of a vehicle 1 and can preferably be executed by a control device 8.

In a first step 18, sensor data of a vehicle environment U of at least one sensor 6 are received and evaluated by the control device 8.

In a further step 20, control commands are output to at least one signal generator 10, 12, 14 when at least one person 4 is detected in the vehicle environment U.

Different signal generators 10, 12, 14 can be actuated by the control device 8 with an adjustable intensity or power depending on a position of the person 4 relative to the vehicle 1 and a distance between the person 4 and the vehicle 1.

Subsequently 22, a warning signal that is tactilely and/or haptically perceptible to the person 4 in the vehicle environment U is output by means of the at least one actuated signal generator 10, 12, 14.

1. An assembly for outputting tactile and/or haptic warning signals in a vehicle environment of a vehicle, comprising:
at least one sensor configured to scan the vehicle environment and for to detect sensor data;
at least one signal generator configured to output a warning signal, the warning signal tactilely and/or haptically perceptible to people in the vehicle environment; and
a control device configured to receive and to evaluate the detected sensor data, the control device further configured to generate control commands for actuating the at least one signal generator when a person is detected in the vehicle environment.

2. The assembly according to claim 1, wherein the at least one signal generator includes a pressurized air nozzle, an infrared source, and/or a vibration unit.

3. The assembly according to claim 1, wherein the control device is configured to generate control commands for actuating one or more signal generators of the at least one signal generator.

4. The assembly according to claim 1, wherein different signal generators of the at least one signal generator are arranged in different regions of the vehicle.

5. The assembly according to claim 1, wherein a pulse or a pulse pattern is output by the at least one signal generator.

6. The assembly according to claim 1, wherein the at least one signal generator has an effective radius in the vehicle environment that is at least three meters.

7. The assembly according to claim 1, wherein:
the at least one signal generator is arranged on the vehicle, and
signal generators of the at least one signal generator are actuated separately or in combination by the control device.

8. A method for outputting warning signals in a vehicle environment of a vehicle, comprising:
receiving sensor data from a vehicle environment using a control device;
evaluating the received sensor data using the control device;
outputting control commands to at least one signal generator when at least one person is detected in the vehicle environment based on the evaluated sensor data using the control device; and
outputting a warning signal that is tactilely and/or haptically perceptible to the at least one person in the vehicle environment using the at least one actuated signal generator.

9. The method according to claim 8, wherein outputting the warning signal comprises:
actuating the at least one signal generator based on a detected distance between the vehicle and the at least one person in the vehicle environment.

10. The method according to claim 9, wherein outputting the warning signal comprises:
adapting a pulse intensity of the warning signal based on the detected distance.

11. The method according to claim 8, further comprising:
identifying a selection of signal generators of the at least one signal generator; and
wherein outputting the warning signal comprises actuating the selection of the signal generators based on a detected position of the at least one person in the vehicle environment.

12. The method according to claim 8, wherein a control device is configured to carry out the method.

13. The method according to claim 8, wherein a computer program comprises commands which, when the computer program is executed by a computer or a control device, cause the computer or control device to carry out the method.

14. The method according to claim 13, wherein the computer program is stored on a non-transitory machine-readable storage medium.
